(19) United States
(12) Patent Application Publication
(10) Pub. No.: US 2020/0281221 A1
(43) Pub. Date: Sep. 10, 2020

(54) Ginseng, Goji, Dong Quai, and Red Date, Ready to Drink Herbal Tea and derivatives of such

(71) Applicant: WEICHIN CHEN, Haleiwa, HI (US)

(72) Inventor: WEICHIN CHEN, Haleiwa, HI (US)

(21) Appl. No.: 16/293,639

(22) Filed: Mar. 6, 2019

(51) Int. Cl. A23F 3/34; A23F 3/18; A23F 3/40

(52) U.S. Cl. CPC A23F 3/34; A23F 3/405; A23F 3/18

(57) ABSTRACT

This is an invention of a process and combination of ingredients to bring a novel tea that is ready to drink. This tea is ginseng, goji berry, don quai, and red date based, not tea leaf based. There are currently no other products on the United States market that is similar to this one hence the novelty. The process of making a drinkable product that is shelf stable include brewing the ingredients, and adding additional flavoring agents and or compounds.

Brewing the ingredient requires a long process of initially high heat (up to 210 degrees Fahrenheit), then rapidly cooling the vessel to allow a slow brewing process of down to 50 degrees Fahrenheit for at least 3 hours. This tea has a lot of solid material left over from the brewing process and is not easy to drink with the remaining particles, hence the filtration process is integral to allow for a ready to drink product with the proper texture. Without the filtration process, this product is not viable.

A ready to drink tea made of ginseng, goji berries, dong quai (Angelica sinensis), and red date with or without other natural/organic ingredients, sweeteners, vitamins, carbonation, caffeine, and or flavors that is shelf stable for at least 6 months.

### CROSS-REFERENCE TO RELATED APPLICATIONS

Not applicable

### STATEMENT REGARDING FEDERALLY SPONSORED RESEARCH OR DEVELOPMENT (IF APPLICABLE)

Not applicable

### REFERENCE TO SEQUENCE LISTING, A TABLE, OR A COMPUTER PROGRAM LISTING COMPACT DISC APPENDIX (IF APPLICABLE)

Not applicable

### BACKGROUND OF THE INVENTION

Ginseng tea has been previously described by multiple patents in China ranging from mixture of Ginseng with different tea leaves, herbs not limited to Astragalus, and multiple fruits. In the United States, patents are numerous in regards to Ginseng mixed with numerous separate ingredients such as coffee, green tea, taurine, chrysanthemum, herbal powders, perilla, food powder, radix, licorice, cinnamon, ginger, jasmine, honey, black ginger, vitamins, chondroiton, cactus fruit, lotus leaf, phloratannin, caffeine, and goji berries.

There are numerous health benefits reported for ginseng, goji berries, red dates, and don quai. As such, there is a resurgence of using these products as drinks/teas.

Currently, no patent has reported a ready to made drink of the combination of ginseng, red dates, dong quai, and goji berries. This includes any tea leaf based teas, as this combination has not been reported in an previous patents. Many use a tea leaf based drink with the addition of ginseng as a flavor. However, this invention uses ginseng as the basis of the tea. The process of making a ready to drink and brewing this tea is part of this invention for a shelf stable product.

### BRIEF SUMMARY OF THE INVENTION

The process of brewing ginseng, red dates, dong quai, and goji berries require a temperature of at least 50 degrees Fahrenheit and above of at least one hour. Flavored or filtered water can be used. Sweeteners, flavorings, and or other natural/synthetic compounds can be added. The beverage can be sealed in a container for commercial distribution and be capable of stable storage for more than one month at room temperature, or at least six months at room temperature. A variety of filtering, irradiating, heating, centrifugation, or treatment methods, or a combination of these, can be used to produce a beverage capable of stable storage over a period of time. Other similar or compatible methods known or available in the art can also be used.

In addition, the invention includes methods of selecting appropriate combinations of ginseng, goji berry, red dates, and or dong quai products, conditions, manufacturing steps, or additives or ingredients to produce a shelf-stable product, and particularly a product capable of being stored as a ready-to-drink beverage in a container for at least one month at room temperature, or at least two months at room temperature, or at least three months at room temperature, or at least six months at room temperature.

### BRIEF DESCRIPTION OF THE SEVERAL VIEWS OF THE DRAWING

Not applicable.

### DETAILED DESCRIPTION OF THE INVENTION

Stainless steel and or any other vessels/containers are used for the brewing process. Either filtered or flavored water is used as the basis. Any combination of whole solid, partial solid, or flavoring are used that contain any parts or combinations of ginseng, red dates, don quai, and goji berries. This can include any ratios of these ingredients to promote the optimal flavor of the tea. Any additional flavoring agent, stabilizer, products, additives, and or sweeteners are places. The water is set to boiling temperature first (up to 210 degrees Fahrenheit) then set to between 50-100 degree Fahrenheit to allow the brewing of the tea. Once brewing is finished, at least 3 hours at sea level atmospheric pressure equivalent, then the product is filtered through crude and micro filtration mechanical mechanisms, and or centrifugation means to strain solids away.

The tea can also be brewed in a pressurized or unpressurized system. Additional polyphenols, flavanols, procyanidins, acids, or polymeric form of these compounds, and or antioxidants can be added. This product can then be carbonized and or have caffeine added for either a carbonized drink, and or energy drink. The product can be flashed cooled and placed into bottles (glass, metal, or plastic). Heat sterilization can occur as per sterilization guidelines.

### Claims or Claims

The final product is a ready to drink tea that is shelf stable.
1. A ready to drink shelf stable product for at least 3 months that include a combination of ginseng, goji berries, don quai, and red dates; with or without other natural/organic ingredients, sweeteners, vitamins, caffeine, and or flavors.
   1. The method of claim 1 where the tea is brewed in water that is between 50 to 210 degrees Fahrenheit.
   2. The method of claim 1 where the beverage is shelf stable for at least 3 months
   3. The method of claim 1 where filtering solids include centrifugation, mechanical, and or other filtration methods.
   4. The method of claim 1 may include natural/organic ingredients not limited to chrysanthemum tea, green tea, black tea, oolong tea, Yerba tea, Rooibos tea, Pu'erth tea, or other tea leaf products. May include any fruit products or fruit flavoring that is on the market.
   5. The method of claim 1 also may include making the tea carbonated
   6. The method of claim 5 also includes any combination of natural/organic ingredients of claim 4.
   7. The method of claim 1 also includes sweeteners that are organic, natural, man made, or sugar alcohol based.
   8. The method of claim 1 also includes additional vitamins, caffeine, and or shelf stabilizers.
   9. The method of claim 1 may also include adding caffeine for an energy drink that may or may not include carbonation.

### Abstract of the Disclosure

This is an invention of a process and combination of ingredients to bring a novel tea that is ready to drink. This tea is ginseng, goji berry, don quai, and red date based, not tea leaf based. There are currently no other products on the United States market that is similar to this one hence the novelty. The process of making a drinkable product that is shelf stable include brewing the ingredients, and adding additional flavoring agents and or compounds.

Brewing the ingredient requires a long process of initially high heat (up to 210 degrees Fahrenheit), then rapidly cooling the vessel to allow a slow brewing process of down to 50 degrees Fahrenheit for at least 3 hours. This tea has a lot of solid material left over from the brewing process and is not easy to drink with the remaining particles, hence the filtration process is integral to allow for a ready to drink product with the proper texture. Without the filtration process, this product is not viable.

### DRAWINGS

Not applicable.

### CITATIONS

CN1135843A 1996-03-01 1996-11-20. [symbol] Ginseng Tea

CN104413192A 2013-08-21 2015-03-18 [symbol] Qi-tonifying health caring ginseng tea.

CN1136781C 2001-01-18 2004-02-04 [symbol] Mixed ginseng tea

CN105267694A 2015-11-16 2016-01-27 [symbol] Health care ginseng tea for conditioning coronary heart diseases

CN1090988A 1993-12-24 1994-08-24 [symbol] Ginseng tea

CN1232625A 1999-05-14 1995-10-27 [symbol] , [symbol] , [symbol] , [symbol] Slender acan-thopanax-ginseng tea

CN102356792A 2011-08-29 2012-02-22 [symbol] , [symbol] , [symbol] Cordyceps militarism and American Ginseng Tea

CN103749827A 2014-01-06-17 [symbol] , [symbol] , [symbol] , [symbol] , [symbol] , [symbol] , [symbol] [symbol] , [symbol] , [symbol] , [symbol] , [symbol] Preparation method of red ginseng/fig tea

CN104472698A 2014-10-23 2015-04-01 [symbol] , [symbol] , [symbol] Ginseng tea-pawpaw yogurt with fruit granules and preparing method thereof

CN101103750A 2007-08-08 2008-01-16 [symbol] Pseudo-ginseng health care Pu'er tea CN106106925A 2016-06-28 2016-11-16 [symbol] Formula and production technology of ginseng-mace substitutional tea

CN103892002B 2014-07-02 2015-06-10 [symbol] Ginseng and Chinese wolf berry tea capable of benefiting vital energy and replenishing blood

CN100452995C 2003-02-16 2009-01-21 [symbol] , [symbol] , [symbol] , [symbol] Active American ginseng health care beverage and fruit tea

CN104782854A 2015-05-13 2015-07-22 [symbol] Lemon, apple, and American ginseng liubao tea.

CN104322746A 2014-10-20 2015-02-04 [symbol] American ginseng health tea capable of tonifying qi and nourishing yin and preparation method of American ginseng health tea.

CN104770513A 2014-01-11 2015-07-15 [symbol] , [symbol] , [symbol] , [symbol] , [symbol] , [symbol] , [symbol] [symbol] Western red ginseng-amorphophallus konjac tea preparaion method

CN1199574C 2000-11-12 2005-05-04 [symbol] Green tea mixed with ginseng and honey-suckle

CN104171 189A 2014-08-05 2014-12-03 [symbol] Ginseng-Cordyceps militaris health tea and preparation method thereof

U.S. Pat. No. 6,210,738B1 1999-11-12 2001-04-03 E Excel International Freeze-dried ginseng berry tea

U.S. Pat. No. 7,354,607B2 2005-01-13 2008-04-08 CJ CheilJedang Corp Drink containing ultra fine powder of ginseng and the method thereof

U.S. Pat. No. 6,586,017 2001-03-09 2003-07-01 Shinhan Sha, Noboru Yanaihara Composition comprising pan pseudo ginseng, eucommiae ulmoides, and polygonati rhizoma

U.S. Pat. No. 6,004,609 1997-01-17 1999-12-21 Sang Jun Lee Ginseng processing method and processed ginseng prepared by the same

U.S. Pat. No. 8,377,449 2011-02-07 2013-02-19 Tatianna Sanabria Five part herbal cleanse protocol (detoxifying tea, townifying tea, relaxing tea, parasite tea, intestinal tea) in conjunction with yoga and a vegan alkalinizing food and juice cleanse program

US20090162523A1 2007-12-25 2009-06-25 Beijing Aotengxunda Science and Tech Co Ltd Ginseng nutritious instant tea and preparation method thereof

US20070031568A1 2006-08-14 2007-02-08 Norhern Innovations and Formulations Corp Supplemental dietary composition including caffeine, taurine, and ginseng US20160263169A1 2015-08-19 2016-09-15 Ginseng Science Inc Composition comprising an extract of combined herb consisting of heat processed ginseng, houttuyniae herb, perilla leaf, and tea leaf or the processed extract thereof as an active ingredient showing hair-stimulating activity and preventing activity from hair loss, and the use thereof

U.S. Pat. No. 7,232,585B2 2004-06-24 2007-06-19 XEL Herbaceuticals Inc Green tea formulations and methods of preparation

US20160101042A1 2014-05-30 2016-04-14 Amorepacific Corp Composition comprising an extract of herbal medicine processed by an oriental herbal medicine processing

U.S. Pat. No. 5,230,889A 1992-02-19 1993-07-27 Iwatani Sangyo KK Enriched nutritious food product comprising powder of ginseng and method of producing powder of ginseng

US20050244516A1 2005-04-07 2005-11-03 Aboca SpA Societa Agricola Compositions for herbal teas enriched with dried plant extracts

U.S. Pat. No. 7,074,440B2 2003-02-26 2006-07-11 Rulin Xiu Compositions and methods for body weight loss

US20050079234A1 2004-08-27 2005-04-14 Yang Chi Chiang School of Medical Technology Chung Shan Medical University Compositions comprising herbs and methods of immunomodulation'

US20150017278A1 2014-05-07 2015-01-15 Carlton R. Branker Method for weight loss and management and herbal composition for achieving the same

U.S. Pat. No. 6,458,361 B1 2001-07-17 2002-10-01 China Japan Feida Union Co Ltd Method of producing a liquid composition comprising ginseng, codyceps, and Ganoderma lucidum

US20090104323A1 2007-05-11 2009-04-23 Jun Won Lee Method of making a blackginseng and condensed black-ginseng and a black-ginseng preserved in honey

US20060228431A1 2005-04-07 2006-10-12 Carrington Tea Co LLC Nutriceutical tea

U.S. Pat. No. 6,576,286B1 1999-04-23 2003-06-10 E Excel International Inc Cactus fruit drinks and food products

US20060008540A1 2004-11-16 2006-01-12 Rulin Xiu Herbal compositions comprising portaluca

U.S. Pat. No. 7,815,960B2 2007-06-2018 2010-10-19 Danyi Quan, Xiong Wade W Green tea formulations US20170119772A1 2016-08-04 2017-05-04 BOTAMEDI Inc Beverage composition comprising phlorotannin, ginseng extract, and caffeine.

1. A ready to drink shelf stable product for at least 3 months that include a combination of ginseng, goji berries, don quai, and red dates; with or without other natural/organic ingredients, sweeteners, vitamins, caffeine, and or flavors.

1. The method of claim 1 where the tea is brewed in water that is between 50 to 210 degrees Fahrenheit.

2. The method of claim 1 where the beverage is shelf stable for at least 3 months

3. The method of claim 1 where a large porous bag, and or metal container is used to contain the ingredients during brewing.

4. The method of claim 1 where filtering solids include centrifugation, mechanical, and or other filtration methods.

5. The method of claim 1 may include natural/organic ingredients not limited to chrysanthemum tea, green tea, black tea, oolong tea, Yerba tea, Rooibos tea, Pu'erth tea, and or any other tea products. May include any fruit products, fruit extracts, or fruit flavoring agents that is on the market.

6. The method of claim 1 also may include making the tea carbonated.

7. The method of claim 1 also includes natural, organic, and or any combination of natural or organic labeled products.

8. The method of claim 5 also includes any combination of natural/organic ingredients of claim 5.

9. The method of claim 1 also includes sweeteners that are organic, natural, man made, or sugar alcohol based.

10. The method of claim 1 also includes additional vitamins, caffeine, and or shelf stabilizers.

11. The method of claim 1 may also include adding caffeine for an energy drink that may or may not include carbonation.
